(19) United States
(12) Patent Application Publication
(10) Pub. No.: US 2008/0184264 A1
(43) Pub. Date: Jul. 31, 2008

(54) Method, Apparatus and Media for Information Model Data Retrieval

(75) Inventors: John M Gatti, Leander, TX (US); Radhakrishna Reddy Dasari, Round Rock, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/627,843

(22) Filed: Jan. 26, 2007

(51) Int. Cl. G06F 9/44

(52) U.S. Cl. 719/316

(57) ABSTRACT

A computer implemented method that may include receiving an object manager request within an object oriented model, wherein said model comprises a first object manager comprising a first data format and a second object manager comprising a second data format different than the first data format and wherein the request is from the first object manager for information regarding a managed object managed by the second object manager. The method may also include intercepting the object manager request with a proxy provider able to communicate with the second object manager. The method may also include generating with the proxy provider a proxy request for information to the second object manager regarding the managed object managed by the second object manager.

### BACKGROUND

1. Technical Field

The present disclosure relates generally to information handling systems and more particularly, to object-oriented management information models.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the capabilities, diversity, and size of computer systems and networks continue to increase, the complexity of systems management also increases. Developing and unifying management standards for desktop, enterprise and Internet environments is a main goal of the Distributed Management Task Force, Inc. (DMTF). DMTF standards are platform-independent and technology neutral, and facilitate cost effective system management. The DMTF's Common Information Model (CIM) standard is an object-oriented management information model that unifies and extends existing management standards, such as Simple Network Management Protocol (SNMP), Desktop Management Interface (DMI), and Common Management Information Protocol (CMIP). The CIM specification defines the syntax and rules of the model and how CIM can be integrated with other management models, while the CIM schema comprises the descriptions of the models.

The CIM standard schema may define thousands of classes with properties and associations for logical and physical modeling. The schema may represent one or many components of an information handling system including, but not limited to, fans, power supplies, processors, and firmware. The CIM schema class definitions may also include methods. Organization of the classes is accomplished by use of namespaces, which function as logical databases. DMTF Profiles are specifications that define the CIM model and associated behavior for a management domain. The profiles define requirements regarding the classes and associations used to represent the management information in a given management domain. Generally, within a CIM Object Manager (CIMOM), profiles are implemented by different providers in one or more namespaces. The CIMOM provides an interface, which allows a provider to expose the instances of CIM classes, and a client application to read and/or write properties and invoke methods.

The CIM Schema allows for definitions of association classes. Association classes define a relationship between two associated classes, for example, a computer system and the cooling fans on that system. The association may be enumerated so that all relationships of an instance of a class to instances of its related class can be viewed. Use of the association class also allows traversal of the relationship starting from the related class instance through the association class to all associated instances, for example from a specific cooling fan to the associated computer system.

The current CIM implementations support associations and related operations when all classes exist in the same CIMOM. The current implementations do not address associations and related operations when one of the associated classes is served by another CIMOM of a different type, that is, in a heterogeneous CIMOM environment. The host CIMOM where the association class resides cannot get and/or access the associated class from a foreign CIMOM since the communication and connection protocols are different from the native version used within a homogeneous CIMOM structure.

The current implementations limit visibility of classes to within a namespace. Therefore, an association cannot be traversed from a local associated class to a local association class and to another foreign associated class. This exacerbates the problem of translating the request and response between the CIMOMs in a heterogeneous CIMOM environment due to the communication and connection issues described above.

Examples that require these cross CIMOM associations include embedded intelligent controllers such as hardware cards and remote access cards. These controllers have an embedded CIMOM and provide controller specific data directly to clients. However, the classes defined on these controllers are also associated with the computer system on which the controller resides.

Generally, an association class is defined in a CIMOM with two associated classes. Each association instance maps an instance of one associated class to an instance of the other associated class. When the association class is enumerated, the instance provider registered for the association class is triggered. The instance provider registered for the association class contains the information needed to build a list of association instances. There may be several association instances containing a particular associated class instance with a different associated class instance. The returned associated class information is a full instance identification string, including the CIMOM host name, namespace and instance identification information.

A client may request the full instance data for the associated class instance using this full path information. However, when the instance path refers to an instance that resides on another CIMOM of a different type, the data may not be acquired.

### SUMMARY

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

According to one embodiment, a method for handling an object manager request within an object oriented model is disclosed. The method may include receiving an object manager request within an object oriented model, wherein said model comprises a first object manager comprising a first data format and a second object manager comprising a second data format different than the first data format and wherein the request is from the first object manager for information regarding a managed object managed by the second object manager. The method may also include intercepting the object manager request with a proxy provider able to communicate with the second object manager. The method may also include generating with the proxy provider a proxy request for information to the second object manager regarding the managed object managed by the second object manager.

According to another embodiment, an information handling system is disclosed. The system may include a processor and memory accessible by the processor. The system may also include Instructions stored on the memory for handling an object manager request within an object oriented model, wherein said model comprises a first object manager comprising a first data format and a second object manager comprising a second data format, wherein said first and second data formats are different from one another, and wherein the request is from the first object manager for information regarding a managed object managed by the second object manager. The instructions when carried out may cause the system to intercept the object manager request with a proxy provider able to communicate with the second object manager and/or generate with the proxy provider a proxy request for information to the second object manager regarding the managed object managed by the second object manager.

According to another non-limiting embodiment, a computer-readable medium having stored thereon an object oriented model is disclosed. The model may include one or more of a first object manager having a first data format; a second object manager having a second data format; a managed object managed by the second object manager; and a proxy provider configured to process requests from the first object manager for information about the managed object, obtain the information from the second object manager, and provide the information to the first object manager.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 depicts non-limiting relationships of several objects of a first object-oriented model comprising a heterogeneous object manager environment.

FIG. 2 is a flowchart illustrating an example method for foreign class retrieval.

FIG. 3 depicts non-limiting relationships of several objects of a second object-oriented model comprising a heterogeneous object manager environment.

FIG. 4 is a flowchart illustrating an example method for association traversal.

### DETAILED DESCRIPTION

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

The methods, apparatus and media of the present disclosure provide an object manager data provider that may function as a proxy provider and a translation provider in an object-oriented model, for example a CIM. Generally, the proxy/translation provider (referred to hereafter as “proxy provider”) is triggered by a request for a path to a foreign object in the model. The foreign object may be any object of an information model, such as a class, and may be any type of object for example, an associated class or an association class. As used herein the terms “host”, “local” and “native” may be used interchangeably. Whether an object is referred to as “local” or “foreign” is based on a reference object, thus these are relative terms. An object may be considered foreign in one situation while considered local in another situation. The phrase “heterogeneous object manager environment/structure” indicates the presence of at least one local object manager, for example a CIMOM, and one foreign object manager, for example a CIMOM, wherein the object managers are different types and have different communication and connection formats/protocols from one another. The proxy provider of the present disclosure enables data exchange between the local and foreign object managers in part by serving as a translator.

In an illustrative embodiment, the methods, apparatus and products of the present disclosure allow retrieval of a foreign associated class in a heterogeneous object manager environment. Generally, the definition of the foreign association class may be copied by the proxy provider and represented locally within the host object manager where the local associated class and local association class reside. The local copy of the foreign class definition may be created when the host object manager undergoes configuration. The proxy provider may also hijack the association link and substitute a path to the proxy provider itself, while retaining the original/actual path. Thus, when a client makes a request for the foreign class path, the request may now be routed to and trigger the proxy provider. The proxy provider matches the requested class path to the previously saved original class path, and establishes a connection to the foreign object manager using the foreign object manager's native connection format. The proxy provider may function as a client and makes a request to the foreign object manager for the actual class instance. The instance data may be returned to the proxy provider in the foreign object manager's format. The proxy provider may then translate the data from the foreign format into the format of the local object manager. This data may then be used to create an instance in the native format of the local/host object manager. This instance may then be returned to the client. It is transparent to the client that the instance data actually came from another object manager, i.e., a foreign object manager.

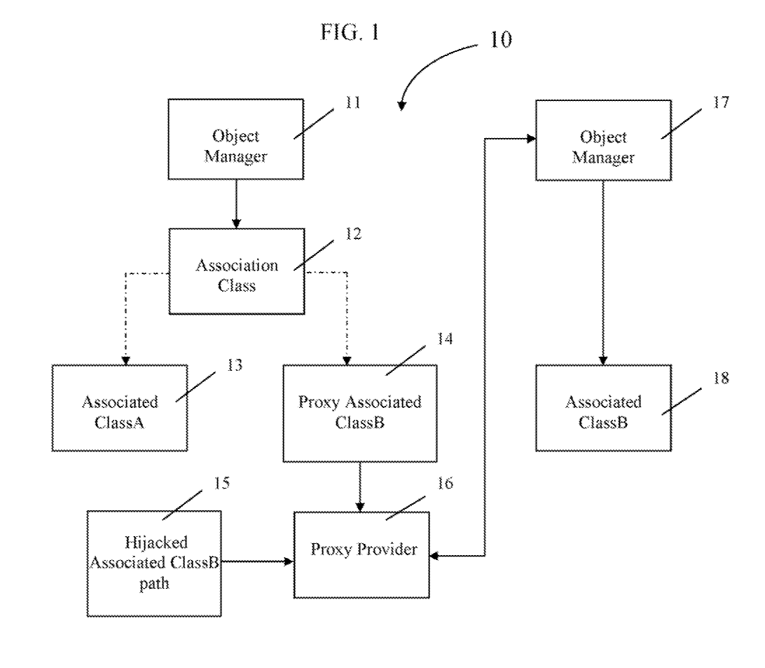

Referring now to FIG. 1, map 10 depicts non-limiting relationships of relevant objects in a heterogeneous object manager environment in an object-oriented model. All or parts of this model may reside on one or more information handling systems. In one non-limiting embodiment, the model is a CIM and the object managers are CIMOMs. Association class 12 resides in Object Manager 11 and associates instances of Associated ClassA 13 and instances of Associated ClassB 18. Associated ClassA 13 may be referred to as a local class with respect to Association class 12 because they both reside in the same host object manager, Object Manager 11, Associated ClassB 18 may be referred to as a foreign class with respect to Association class 12 and Associated ClassA 13 because it resides in a different/foreign object manager, Object Manager 17. A copy of the class definition for Associated ClassB 18 is represented locally (with respect to Object Manager 11) as Proxy Associated ClassB 14. The class path to Associated ClassB 18 is hijacked by Proxy Provider 16 and represented locally as Hijacked Associated ClassB path 15, which redirects the actual class path to Proxy Provider 16. As indicated in FIG. 1. Proxy Provider 16 and Object Manager 17 may communicate with one another.

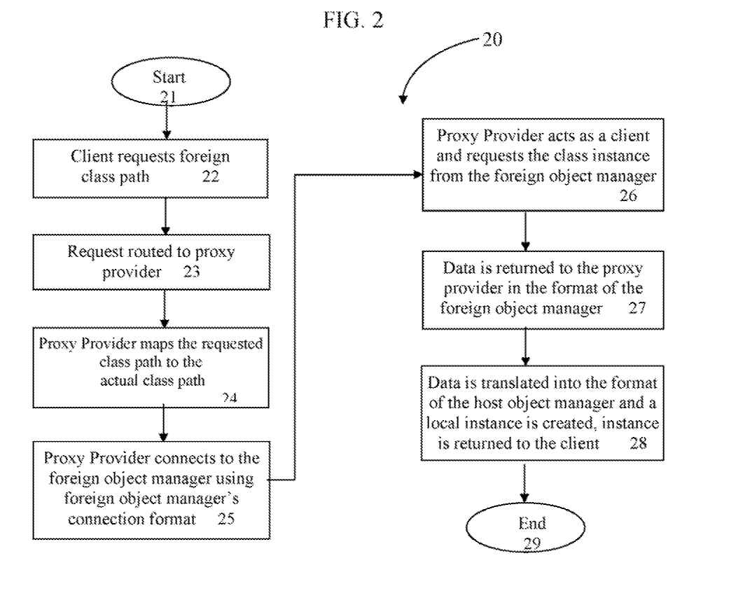

FIG. 2 depicts a flowchart 20 illustrating an example method for retrieving instance data of a foreign associated class, for example Associated Class 18 of FIG. 1, in a heterogeneous object manager environment in an object-oriented model. In one non-limiting embodiment, the model is a CIM and the object managers are CIMOMs. Various methods are contemplated comprising all or less than all of the steps shown in FIG. 2, any number of repeats of any of the steps shown, and in any order. A non-limiting example of one method starts in step 21. The client may make a request for a foreign class path in step 22. The request may be routed to the proxy provider in step 23. In step 24, the proxy provider may map the requested class path to the actual class path. In step 25, the proxy provider may connect to the foreign object manager using the foreign object manager's connection format. The proxy provider may act as a client in step 26 and request the foreign class instance from the foreign object manager. In step 27, the instance data may be returned to the proxy provider in the foreign object manager's format. In step 28, the proxy provider may translate the data from the foreign format into the format of the host/local object manager. The local instance data may be returned to the client and the method ends in step 29.

In still other non-limiting embodiments, the methods, apparatus and products of the present disclosure allow traversal from a local associated instance through a foreign association class in a heterogeneous object manager environment. One non-limiting example requiring such a traversal is when a client requests any class instance(s) associated with an associated class of interest, and one or more of the resulting associated class instances, as well as the association class, are foreign.

Generally, when a client requests a foreign associated instance of a specified local class instance, the client's request may be sent to the local object manager, which may be any object manager such as a CIMOM. The host object manager may search its class definition database, which may comprise managed object format (MOF) data, for any association classes that contain a reference to the associated class of interest. For each association class found, an enumeration of the association class may be performed. Within the enumeration, any instance(s) that contains a match to the associated instance of interest may be identified. The instance may be retrieved for example by performing a “get” on that instance, and added to the list of associated instances.

In a heterogeneous object manager environment of the present disclosure, a foreign association class may be represented locally as a proxy association class, which is produced by the proxy provider. The instance data for this local association class may include a reference to the actual association class that specifies the full path name of the association class. The reference information may also include the type of the foreign object manager.

A request for this proxy association class may trigger the proxy provider since it is the provider registered for the class. The proxy provider may establish a connection to the foreign object manager using the foreign object manager's connection format. A request may be made for the actual association class instance. The data may be returned to the proxy provider in the foreign object manager's format The data within the instance may be extracted and the proxy provider may translate it into the format of the host object manager, and create an instance in the format of the host object manager. This instance may then be returned to the client. It may be transparent to the client that the instance data actually came from another object manager, i.e., a foreign CIMOM.

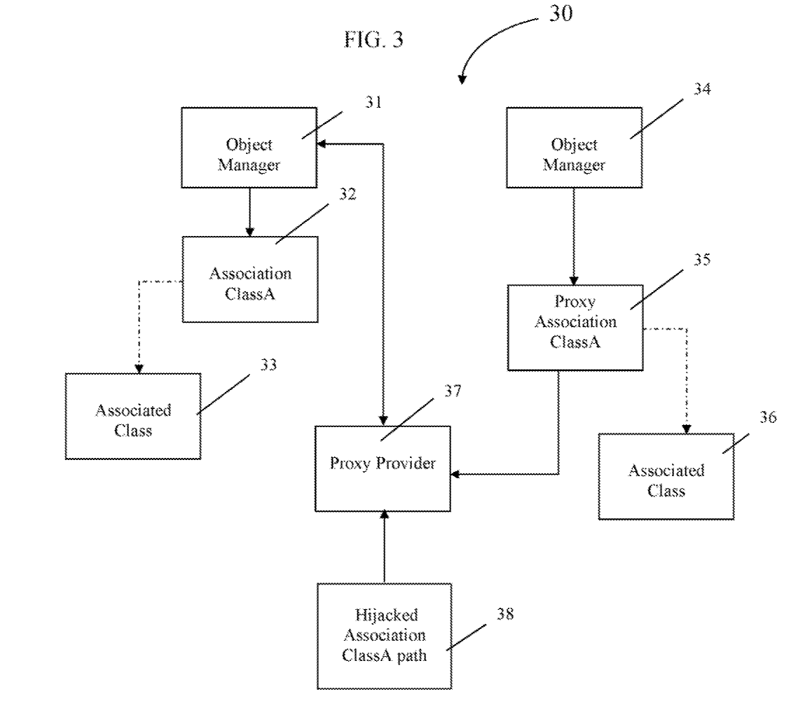

Referring now to FIG. 3, map 30 depicts other non-limiting relationships of relevant objects in a heterogeneous object manager environment in an object-oriented model. All or parts of this model may reside on one or more information handling systems. In one non-limiting embodiment the model is a CIM and the object managers are CIMOMs. For the present discussion of FIG. 3, Associated Class 36 is the reference object for purposes of determining “local” and “foreign.” Association ClassA 32 may associate instances of Associated Crass 33 and Associated Class 36. Association ClassA 32 and Associated Class 33 both reside in foreign Object Manager 31, and are foreign objects with respect to local Associated Class 36 which resides in host Object Manager 34. A copy of the class definition for Association ClassA 32 may be created by Proxy Provider 37 and represented locally (with respect to Object Manager 34) as Proxy Association ClassA 35. The path to foreign Association ClassA 32 may be hijacked by Proxy Provider 37 and represented locally as Hijacked Association ClassA Path 38, which redirects the actual class path to Proxy Provider 37. As indicated in FIG. 3, Proxy Provider 37 and Object Manager 31 may communicate with one another.

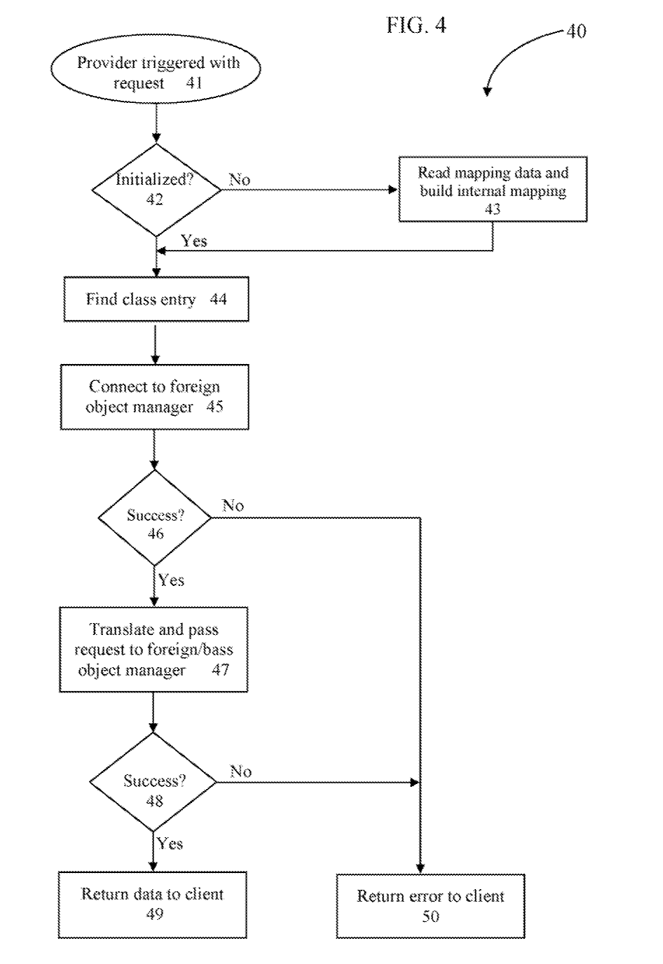

Referring now to FIG. 4, flowchart 40 illustrates a non-limiting example of one method of the disclosure for traversing a foreign association class in a heterogeneous object manager environment in an object-oriented model. In one non-limiting embodiment, the model is a CIM and the object managers are CIMOMs. Various methods are contemplated comprising all or less than all of the steps shown in FIG. 4, any number of any of the steps shown, and in any order. A non-limiting example of one method may start when a client requests any instances associated with a local associated class of interest, as a non-limiting example Associated Class 36 of FIG. 3. The request triggers the provider registered for this class, for example, Proxy Provider 37 in the case of Associated Class 36, and the method starts in step 41. The request may be sent to the host object manager and in step 42 it is determined whether or not the object manager has been initialized. If the answer is no, then in step 43 the object manager undergoes initialization which comprises reading mapping data and building internal mapping. If the answer in step 42 is yes, the object manager has been initialized, and then in step 44 the host object manager may search its class definition database for any association classes that contain a reference to the associated class of interest. In step 45, for any foreign association class instance that contains a match to the associated instance of interest, the proxy provider may connect to the foreign object manager. In step 46 it may be determined whether the connection was successful. If not, the connection to the foreign object manager was not successful, and then in step 50 an error may be returned to the client or there may be one or more additional attempts before returning an error. If the answer to step 46 is yes, then in step 47 the proxy provider may pass the request to the foreign object manager by translating the request from the local format into the foreign object manager's format. In step 48 it may be determined whether the request was successful. If no, the request was not successful, and step 50 may return an error to the client or there may be one or more additional attempts before returning an error. If the answer to step 48 is yes, then in step 49 the instance data may be returned to the client.

In step 48, the data within the retrieved instance may be extracted and the proxy provider may translate it from the foreign object manager's format into the format of the host object manager, and create an instance in the format of the host object manager. This instance may then be returned to the client in step 49. It may be transparent to the client that the instance data actually came from another object manager, i.e., a foreign object manager.

In some embodiments, part or all of the models/data structures described herein may be stored on one or more information handling system readable media or transmitted in a propagated signal. In other embodiments, part or all of the methods described herein may be described as instructions for an information handling system, and stored on one or more information handling system readable media or transmitted by a propagated signal. In even other non-limiting embodiments, there are contemplated information handling systems comprising the above described readable media containing the models/data structures and/or instructions.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

What is claimed is:

1. A computer implemented method comprising:
receiving an object manager request within an object oriented model, wherein said model comprises a first object manager comprising a first data format and a second object manager comprising a second data format different than the first data format and wherein the request is from the first object manager for information regarding a managed object managed by the second object manager;
intercepting the object manager request with a proxy provider able to communicate with the second object manager; and
generating with the proxy provider a proxy request for information to the second object manager regarding the managed object managed by the second object manager.

2. The method of claim 1, wherein said managed object comprises one selected from the group consisting of an associated class and association class.

3. The method of claim 1, wherein said object-oriented model is a common information model (CIM).

4. The method of claim 1, wherein the object manager request is in the first data format, and the proxy request is in the second data format.

5. The method of claim 1, further comprising:
receiving object information with the proxy provider from said second object manager.

6. The method of claim 5, further comprising:
providing the object information from the proxy provider to the first object manager.

7. The method of claim 5, further comprising:
creating a proxy object managed by the first object manager from the object information.

8. The method of claim 1, wherein the object manager request is associated with a first path to the proxy provider, and wherein the proxy request is associated with a second path to the second object manager.

9. The method of claim 1, wherein said object-oriented model is a common information model (CIM), wherein the object manager request is in the first data format, and the proxy request is in the second data format; and wherein the object manager request is associated with a first path to the proxy provider, and wherein the proxy request is associated with a second path to the second object manager, the method further comprising:
receiving object information with the proxy provider from said second object manager.

10. The method of claim 9, further comprising:
providing the object information from the proxy provider to the first object manager.

11. The method of claim 9, further comprising:
creating a proxy object managed by the first object manager from the object information.

12. An information handling system comprising:
a processor;
memory accessible by the processor; and
instructions stored on the memory that when carried out cause the system to:
receive an object manager request within an object oriented model, wherein said model comprises a first object manager comprising a first data format and a second object manager comprising a second data format different than the first data format and wherein the request is from the first object manager for information regarding a managed object managed by the second object manager;
intercept the object manager request with a proxy provider able to communicate with the second object manager; and
generate with the proxy provider a proxy request for information to the second object manager regarding the managed object managed by the second object manager.

13. The system of claim 12, further comprising instructions that when carried out cause the system to:
receive object information with the proxy provider from said second object manager.

14. The system of claim 13, further comprising instructions that when carried out cause the system to:
provide the object information from the proxy provider to the first object manager.

15. The system of claim 13, further comprising instructions that when carried out cause the system to:
create a proxy object managed by the first object manager from the object information.

16. The system of claim 13, wherein the managed object comprises one selected from the group consisting of an associated class and an association class.

17. A computer-readable medium having stored thereon an object oriented model, the model comprising:
a first object manager having a first data format;
a second object manager having a second data format;
a managed object managed by the second object manager;
a proxy provider configured to process requests from the first object manager for information about the managed object, obtain the information from the second object manager, and provide the information to the first object manager.

18. The medium of claim 17, wherein the model further comprises a proxy object managed by the first object manager that corresponds to the managed object.

19. The medium of claim 17, wherein the proxy provider is further configured to create a proxy object managed by the first object manager that corresponds to the managed object.

20. The medium of claim 17, wherein the managed object comprises one selected from the group consisting of an associated class and an association class.
